(19) United States
(12) Patent Application Publication
(10) Pub. No.: US 2002/0191522 A1
(43) Pub. Date: Dec. 19, 2002

(54) DVD audio encoder and decoder

(75) Inventor: Tzueng-Yau Lin, Taichung (TW)

Correspondence Address: HOGAN & HARTSON L.L.P., 500 S. GRAND AVENUE, SUITE 1900, LOS ANGELES, CA, 90071-2611, US

(73) Assignee: Media Tek, Inc.

(21) Appl. No.: 09/851,471

(22) Filed: May 7, 2001

(51) Int. Cl. G11B 7/005

(52) U.S. Cl. 369/59.27

(57) ABSTRACT

Simplified DVD-Audio decoders and encoders are provided. The decoder does not include FIFOs between the depacketizer and the decoder cores. Rather, the decoder cores directly receive data from the depacketizer. Underflow is avoided by spinning the DVD at a speed higher than the nominal, single speed of the DVD, which ensures that data are available at a sufficient rate. Similarly, an encoder provides data directly from an encoding core into a packetizer, eliminating the FIFOs from the data path.

### BACKGROUND OF THE INVENTION

1. Field of the Invention

The present invention relates to storing and retrieving data on an optical storage disk and more particularly to storing and retrieving data representing audio signals on digital versatile disks.

2. Discussion of the Related Art

Digital versatile disk (DVD) audio provides a protocol for the storage and playback of music on optical disks and is proposed to replace or supplement the existing standard of compact disk audio. DVD-Audio is proposed to provide greater data storage and improved quality of reproduced audio signals as compared to compact disk audio. Working group WG4 of the DVD Forum has developed a specification for the storage and playback of DVD-Audio to provide for higher levels of data storage and data security. One characteristic of the DVD-Audio specification is the use of a lossless coding scheme for data compression. Lossless coding refers to a data compression scheme that maintains non-redundant data from the original music signal and replaces redundant data with more compact symbols for transmission or storage so that the encoded signal includes all of the information of the original signal. No data is discarded or lost in the lossless coding scheme of DVD-Audio, which stands in contrast to the lossy coding scheme of compact disk audio. The specific lossless coding scheme used in DVD-Audio is known as Meridian Lossless Packing (MLP) and was developed by Meridian Audio Ltd. of Huntingdon, England. The MLP coding technology is available for licensing in the United States from Dolby Laboratories.

FIG. 1 illustrates a DVD-Audio playback system that can be used to effect the general MLP decoding scheme. Data are read out from a DVD 10 under the control of a system chip 12 that includes servo and data recovery circuitry. As illustrated, the system chip often includes or accesses a memory configured as a FIFO to buffer the flow of data from the DVD 10 and into the depacketizer 14. The depacketizer 14 unpacks the data packets read out from the DVD 10 and recovers additional data as illustrated. The read out data includes up to six data channels, either organized into one substream including all the channels or into two substreams, with the substream 0 corresponding to the basic stereo channels and the substream 1 corresponding to additional audio channels. Data from substream 0 are stored in a corresponding buffer FIFO 16 and data from substream 1 are stored in a corresponding buffer FIFO 18. Decoder cores 20, 22 extract data from their corresponding FIFOs 16, 18 and decode the substream data according to the MLP decompression scheme.

The data output from the decoder cores 20, 22 are processed according to the DVD-Audio matrixing scheme in matrixing circuit 24 and up to six channels of data are output to further audio processing circuitry. Matrixing within the MLP coding scheme provides further decompression of the audio data stored on the DVD 10. Whether a simple two channel stereo signal or a more sophisticated signal including five or more channels, there is often a relatively high level of correlation between the different channels of sound that might be stored on the DVD-Audio disk. This is particularly true for center channel signals or surround sound signals. MLP coding takes advantage of the correlations that are present by extracting the correlations from the signals stored on the DVD to achieve greater levels of data compression. During playback using the circuit of FIG. 1, the correlations between the sound signals for the various channels are reintroduced in the matrixing circuit 24. Again, according to the MLP coding scheme, the matrixing and decompression performed is lossless in that only redundant data are removed from the stored data set.

The illustrated playback circuit of FIG. 1 includes a variable rate decoder. As a general principle, the amount of data needed to produce an audio signal varies greatly. Thus, a limited data set can describe certain regular music signals while a much larger data set is needed to describe a highly random signal such as a cymbal crash. The different amounts of data needed to describe a fixed time interval of music or audio are reflected in the amounts of compression achieved when storing the signals on the DVD. During playback, different amounts of data are read off of the DVD to reproduce intervals of less and more random data. To reproduce regular and predictable intervals, a comparatively smaller amount of data is read from the DVD and to reproduce a near-random interlude a larger amount of data is read from the DVD.

Audio data can be output from the matrixing circuit 24 at a rate, for example, in excess of 13 Mb/sec. The maximum rate at which data can be removed from the DVD is 9.6 Mb/sec. The difference between these numbers reflects in part the fact that the output rate is increased by the decompression of the data stored on the DVD 10. It is possible to output audio data at a rate faster than the data can be read from the disk, even accounting for the expansion provided by decompression, when the data represent a highly random signal. On average this is not the case, as the average data rates for reproducing audio data from a DVD are less than the rate at which data can be retrieved and decoded from the DVD. Still, care must be taken to ensure the decoder has sufficient data to avoid an underflow condition.

For this reason, the playback circuit includes buffer FIFOs 16, 18 between the depacketizer 14 and the decoder cores 20, 22. According to the DVD-Audio specification, a FIFO buffer 0 having a capacity to store 30,000 bytes of data is provided for the substream 0. When six channels are provided, the DVD-Audio specification provides that the combined FIFO buffer 0 and FIFO buffer 1 have a capacity to store 90,000 bytes of data output by the respective substream 0 and substream 1 bitstreams. The depacketizer and the decoder cores 20, 22 together control the buffer FIFOs to provide the desired data flow. These buffer FIFOs fill during intervals of regular audio signals (lower data rates) and prior to reproducing highly random audio signals (high data rates). The buffer FIFOs empty during intervals of peak data reproduction.

FIG. 2 illustrates the processing flow of the decoding circuitry of FIG. 1. If only one substream exists, only the decoder core 0 is active. If there are two substreams, the decoder core 0 is active when only basic reproduction is desired and both decoder core 0 and decoder core 1 are active when additional channels are processed. The decoding circuitry receives a data stream and begins processing an access unit on detecting a major_sync in the data stream. When a major_sync is detected, the circuit reads back within the data to find the minor_sync and derives the input timing from the minor_sync signal. The clock is set to the input timing and the decoding point is established. Data are read from the disk through the depacketizer to fill the respective FIFOs and then the data within the FIFOs are provided to the respective decoder cores when the clock reaches the decoding point.

Within the depacketizer, the data stream is monitored to detect the minor_sync and major_sync as appropriate. The depacketizer reads the substream directory from the properly synched data and stores the substreams in the FIFO corresponding to that substream. The depacketizer continues to read data and reads in the next access unit, as identified by the minor_sync, and establishes the input timing for reading that access unit on the basis of the value read out from that access unit.

When the clock is at the decoding point, the decoder cores decode their respective substreams. The decoder core searches within its respective substream for the restart_header and establishes the output_timing from the readout_header. Data are read out from the FIFOs by the decoder cores, first by searching for the restart_header for an access unit and then by searching for the block_headers of individual blocks within the access unit. With the clock at or beyond the output_timing, the decoder core and the matrixing circuit process the data of the substreams by successively performing Huffman decoding, recorrelating the data, generating dither channels as appropriate. As the decoder core processes a block of data, the output_timing is incremented and additional data are read out. Processing continues block by block until another restart_header is detected and the output_timing is reset to the value indicated by that restart_header.

The depacketizer instantaneously transfers each access_unit at the time given by its input_timing field. When an access_unit having a major_sync is received, the depacketizer strips off the sync and puts each substream into its corresponding FIFO. When the clock is at output_timing, the decoder core decodes one audio frame, removing as much data as needed to decode the audio frame.

As discussed above, the depacketizer and the decoder cores cooperate to ensure that sufficient data are present in the respective FIFOs to avoid an underflow condition. This underflow condition can be stated as:

access_{—}unit_{—}length*16/(output_{—}timing−input_{—}timing)/fs≦9.6 Mb/sec,

where 9.6 Mb/sec is the rate at which data can conventionally be extracted from a DVD.

FIG. 3 shows the encoder that generally corresponds to the MLP encoding scheme discussed above. Up to six audio channels and two dither channels are provided to the matrixing circuitry 30. The audio channels and the dither channels may be provided from studio-quality recording or generating equipment, but might also be provided by the less sophisticated circuitry typical of a personal computer. The matrixing circuitry 30 identifies and encodes correlations between the signal channels. Data from the matrixing circuitry are input to encoder core 0 and encoder core 1, which respectively output data to the corresponding FIFO buffers. Encoder cores 32, 34 perform MLP encoding and lossless data compression and generate the respective substream 0 and substream 1 appropriate to stereo and more complex signal sets. Data output by the encoder cores 32, 34 are buffered in FIFOs 36, 38 to ensure that sufficient data are available to the packetizer 40. Packetizer 40 formats the data into packets and outputs it in a data stream 42 that can be used to write a DVD-Audio disk.

### SUMMARY OF THE PREFERRED EMBODIMENTS

An aspect of the invention provides an audio playback system, comprising a depacketizer circuit coupled to receive packets of audio data from a storage device, the depacketizer circuit extracting data and outputting one or more data streams. The playback system includes at least one decoder core receiving the one or more data streams, the decoder decoding audio data according to a lossless unpacking scheme. The depacketizer circuit and the at least one decoder core are coupled to provide data directly from the depacketizer to the at least one decoder core without buffering.

An aspect of the invention provides an audio playback system comprising a depacketizer provided to receive packets of audio data from a storage device, the depacketizer extracting data and outputting one or more data streams. At least one decoder core receives the one or more data streams. The at least one decoder decodes audio data, wherein the depacketizer and the at least one decoder core are defined within a digital signal processor and provide data directly from the depacketizer to the at least one decoder core within the digital signal processor.

Another aspect of the invention provides an MLP encoding system comprising a matrix circuit receiving a plurality of audio signal channels. First and second encoder cores receive data from the matrix circuit, the first and second encoders implementing MLP encoding on data output by the matrix circuit. A packetizer receives first and second data substreams from the first and second encoders, respectively, and formats audio data into packets for storage on a storage medium. The packetizer circuit and the first and second encoder cores are coupled to provide data directly from the first and second encoder cores directly without buffering.

### BRIEF DESCRIPTION OF THE DRAWINGS

The invention may be better understood from the following description with reference to the drawings, which form part of this disclosure.

FIG. 1 illustrates a playback system for reproducing audio signals stored on a digital versatile disk according to the MLP encoding scheme.

FIG. 2 illustrates a processing flow within the system of FIG. 1.

FIG. 3 illustrates a system adapted to encode data according to the MLP scheme for storage on a DVD-Audio disk.

FIG. 4 illustrates a playback system in accordance with preferred aspects of the present invention for reproducing data stored according to MLP encoding on a DVD-Audio disk.

FIGS. 5A & 5B illustrate a preferred processing flow for the system of FIG. 4.

FIG. 6 illustrates a system in accordance with preferred aspects of the present invention and adapted to encode data according to the MLP scheme for storage on a DVD-Audio disk.

### DETAILED DESCRIPTION OF THE PREFERRED EMBODIMENTS

Preferred embodiments of the present invention provide a simplified data path within an MLP decoder for reproducing data from a DVD-Audio disk. Most preferably, a decoder or a playback circuit provides one or more direct connection paths from a depacketizer to the one or more corresponding decoder cores. Preferably no buffering is provided between the depacketizer and the decoder cores. In a preferred implementation of this decoder, the depacketizer is defined within a digital signal processor (DSP) and the one or more decoder cores is defined within the same DSP. In this way, data pass from the depacketizer to the decoder cores without exiting the DSP and without accessing DRAM or FIFO external to the DSP. This simplified data path provides reduced cost.

The rate at which data are available from a DVD-Audio disk relates to the speed at which the disk is rotated. Thus, the 9.6 Mb/sec data rate discussed above can be improved by spinning the disk at a multiple of the base (1X) rotational rate, for example at twice (2X) or four times (4X) the base rotational rate. Most preferably, a decoder according to the present invention provides a data throughput rate of 14.75 Mb/sec or greater. When such a higher rotational rate is adopted, it is possible to eliminate the FIFOs from the decoder's data path. This is an advantage in that each FIFO requires significant memory and processing and management overhead. Eliminating the FIFOs from the data path simplifies the circuitry and reduces its cost.

Similarly, a preferred encoder includes a simplified data path without FIFOs between the encoder cores and the packetizer. To achieve this configuration, it is particularly preferred that the internal data transmission rate is 14.75 Mb/sec or greater.

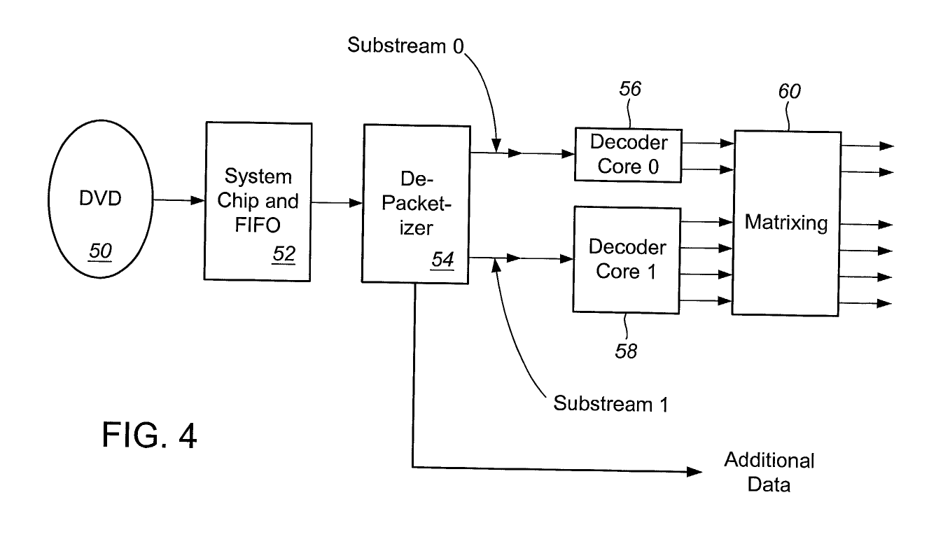

FIG. 4 illustrates a DVD-Audio playback system in accordance with preferred aspects of the present invention that can be used to effect the general MLP decoding scheme. Data are read out from a DVD 50 under the control of a system chip 52 that includes servo and data recovery circuitry. As illustrated, the system chip often includes or accesses a memory configured as a FIFO to buffer the flow of data from the DVD 50 and into the depacketizer 54. The depacketizer 54 unpacks the data packets read out from the DVD 50 and recovers additional data as illustrated. The read out data includes up to six channels, either organized into one substream with all channels or into two substreams with substream 0 corresponding to the basic channels and substream 1 corresponding to additional channels. Data from substream 0 are passed to decoder core 0 and data from substream 1 are passed to the decoder core 1. Decoder cores 56, 58 receive data directly from the depacketizer 54 and decode the substream data according to the MLP decompression scheme.

The data output from the decoder cores 56, 58 are further processed according to the DVD-Audio matrixing scheme in matrixing circuit 60 and up to six channels of data are output to further audio processing circuitry. As was discussed above, matrixing within the MLP coding scheme provides further decompression of the audio data stored on the DVD 50.

Note that, while this discussion has been made in terms of transferring data from a DVD-Audio disk, the decoder can also be used to retrieve and decode data from a different kind of data store, such as a hard disk drive, or for data transmitted over a network or local communications link. For example, a local communications link might be an IEEE 1384 or “firewire” connection.

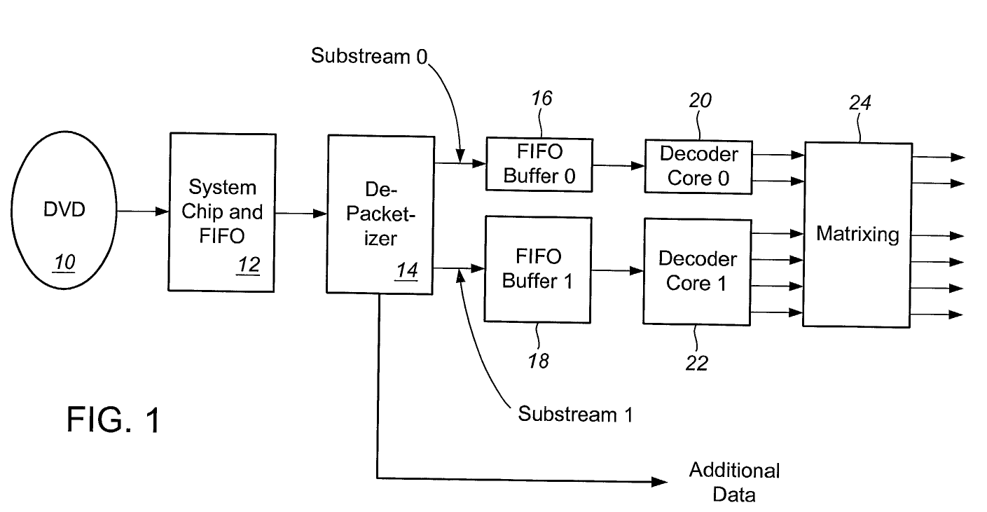

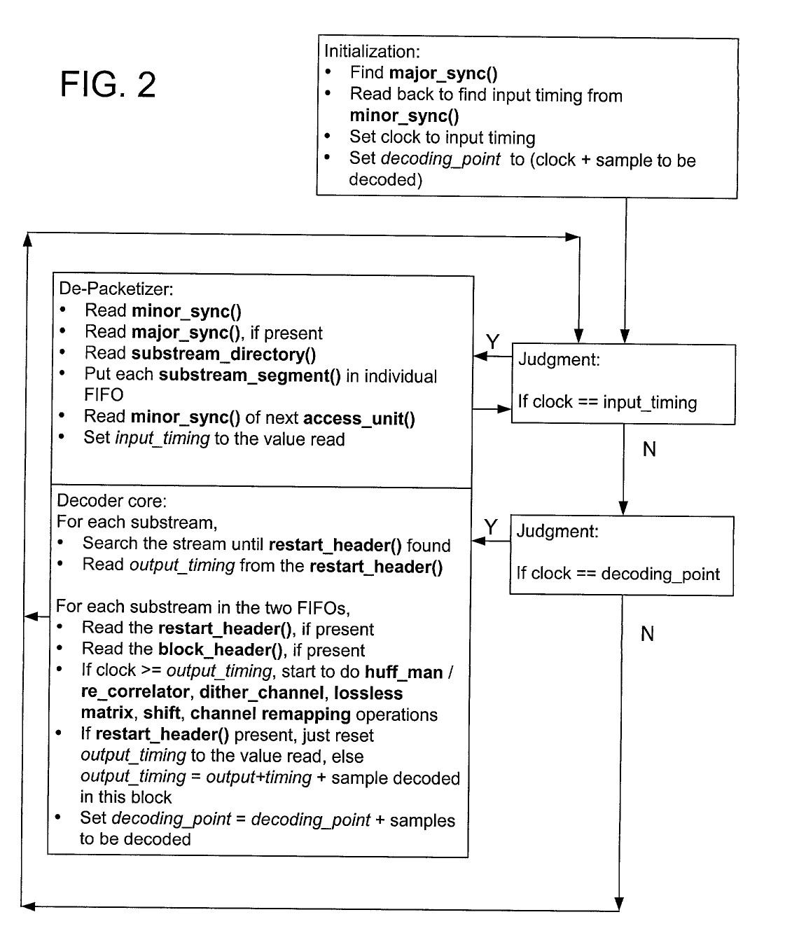

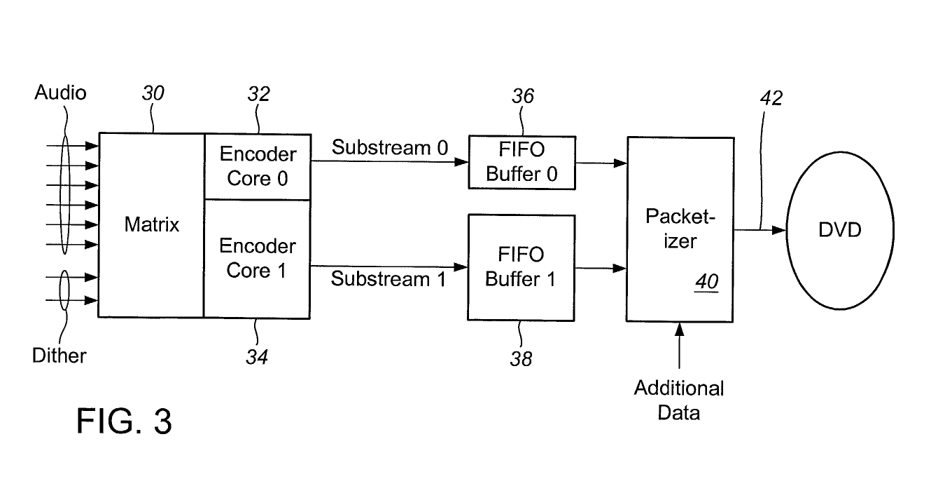

The depacketizer 54 and the one or more decoders are implemented in a digital signal processor (DSP). In addition, the matrixing circuitry is preferably implemented in the same DSP. It is possible and in most cases desirable to implement the system chip on the same chip with the DSP for a fully integrated solution for an MLP decoder. As shown, removing the FIFOs from the decoder data path simplifies the circuitry. This is particularly true because the FIFOs generally are defined in software and physically exist within dynamic random access memory (DRAM) external to the DSP. As such, the FIFOs illustrated in FIG. 1 consume program space within the DSP as well as additional DRAM circuitry. This is avoided in the simplified decoder circuit of FIG. 4.

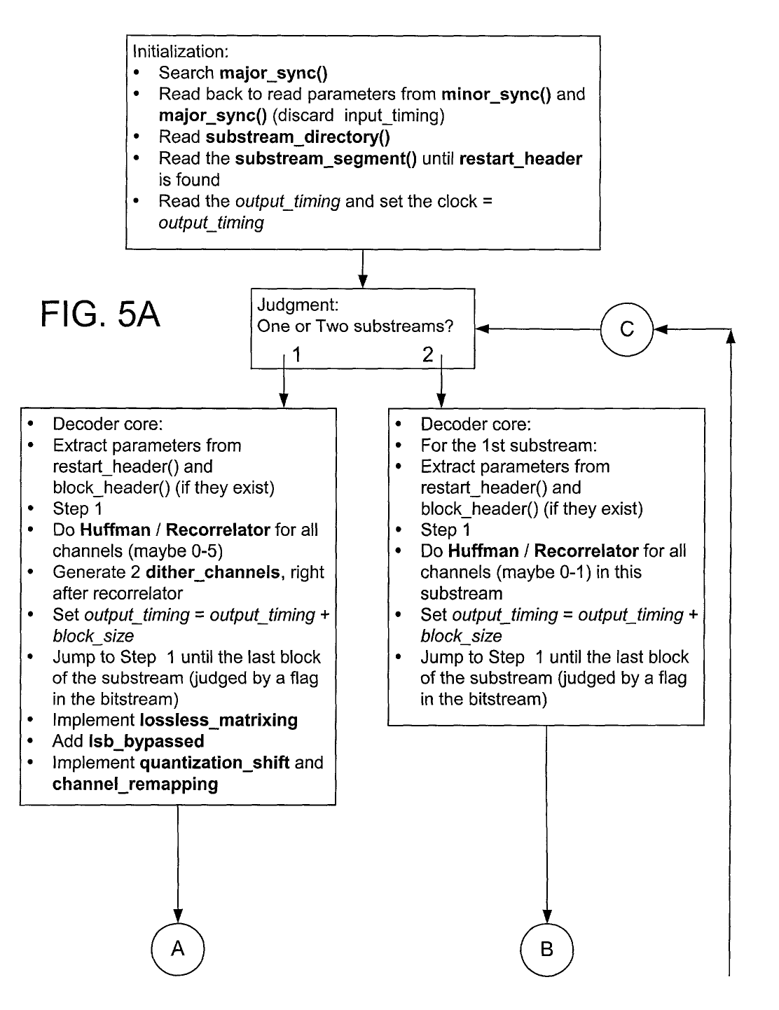

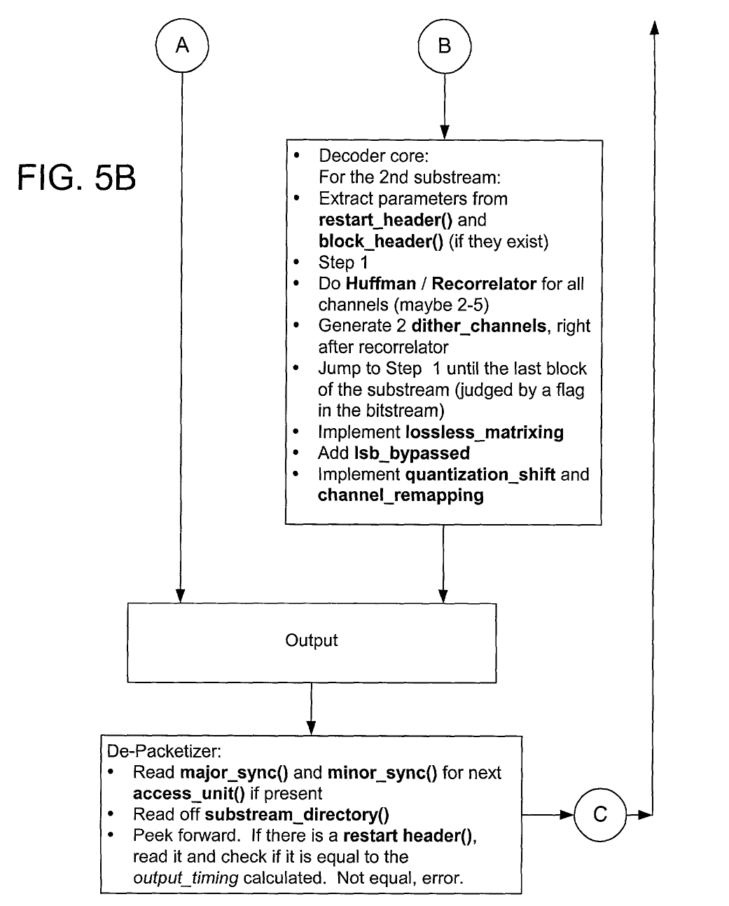

FIGS. 5A & 5B illustrate the processing flow of the decoding circuitry of FIG. 4. If only one substream exists, only the decoder core 0 is active. If there are two substreams, the decoder core 0 is active when only basic reproduction is desired and both decoder core 0 and decoder core 1 are active when additional channels are processed. Input timing is the time at which the access unit is passed to the decoder and output_timing is the sample number of the first sample in the block containing the restart header.

At initialization, the decoding circuitry receives a data stream and begins processing an access unit on detecting a major_sync in the data stream. The depacketizer monitors the data stream to detect the minor_sync and major_sync as appropriate. When a major_sync is detected, the depacketizer circuit reads back within the data to find the minor_sync. The input timing read from the minor_sync is discarded. The depacketizer reads the substream directory and then reads the substream_segment until a restart_header is found. The output_timing is read and the clock is set to the output_timing. The depacketizer continues to read data and reads in the next access unit. The circuit is configured for either one or two substreams, as detected by the circuit, and processing commences accordingly.

Assuming first that stereo processing is desired and only a single substream is generated, substream 0 is provided to decoder core 0. Decoder core 0 extracts timing and other parameters from the restart_header and the block_header, first by searching for the restart_header for an access unit and then by searching for the block_headers of individual blocks within the access unit. Decoder core 0 searches within substream 0 for the restart_header and establishes the output_timing from the readout_header. Data are read into the decoder from the packetizer and decoded by the decoder cores. With the clock at or beyond the output_timing, the decoder core processes the data of the substreams by successively performing Huffman decoding and recorrelating the data. As the decoder core processes a block of data, the output_timing is incremented and additional data are read out. Processing continues block by block until the last block is detected.

Further processing of the decoded access_unit is performed by the matrixing unit. At this point, data are output from the simple stereo implementation. Control returns to the depacketizer, which searches for a major_sync and a minor_sync for the next access_unit. When a new access_unit is recognized, the depacketizer reads the substream directory and continues processing. The depacketizer also peeks forward to detect a restart_header, which is read to extract the output_timing. The read out output_timing is checked against the calculated output_timing to detect an error condition, if present.

When multiple data streams are present, the data path indicated along the right hand side of FIGS. 5A & 5B is followed. The processing is similar to that described above with respect to the single substream stereo implementation and proceeds as illustrated. Additional processing is performed as required by the more sophisticated implementation.

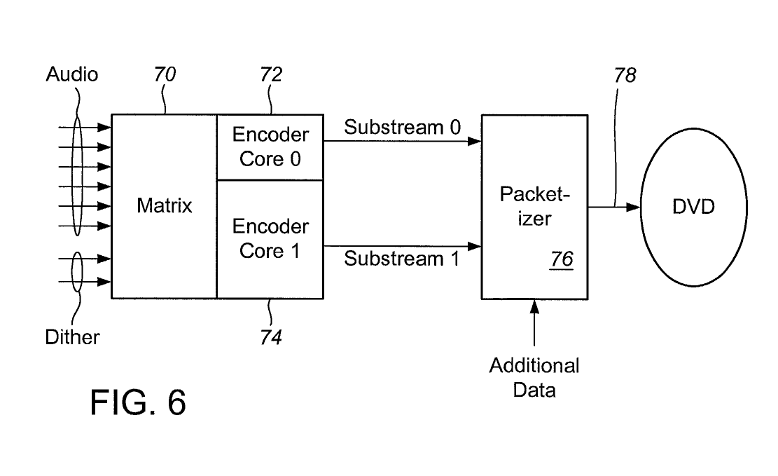

FIG. 6 shows the encoder that generally corresponds to the MLP encoding scheme, simplified by eliminating the FIFOs from the data path. As with the decoding circuitry discussed above, the simplified structure is achieved by utilizing a higher data transmission rate and providing additional communication between the encoders and the packetizing circuit. Six audio channels and two dither channels are provided to the matrixing circuitry 70. The audio channels and the dither channels may be provided from studio-quality recording or generating equipment, but might also be provided by the less sophisticated circuitry typical of a personal computer. The matrixing circuitry 70 identifies and encodes correlations between the signal channels. Data from the matrixing circuitry are input to encoder core 0 and encoder core 1, which respectively output data to the corresponding encoder cores. Encoder cores 72, 74 perform MLP encoding and lossless data compression and generate the respective substream 0 and substream 1 appropriate to stereo and more complex signal sets. Data output by the encoders 32, 34 are provided directly to the packetizer 76. Packetizer 76 formats the data into packets and outputs it in a data stream 78 that can be used to write a DVD-Audio disk. The simplified encoder of FIG. 6 provides an internal data rate of 14.75 Mb/sec or greater to ensure that sufficient data are available to the packetizer 76.

Aspects of the data structure and the decoding and encoding flow are summarized in the following. As discussed above, this generally corresponds to the hierarchy for reading data out from a DVD-Audio disk and for storing data onto a DVD-Audio disk.

1.
access_unit( )
{

minor_sync( );
If (major_sync)

major_sync( );

substream_directory( );
Start:
For (i = 0; i < substreams; i++)

{

substream_segment( );

if (crc_present[i])

{
substream_parity;

substream_crc

}

}

EXTRA DATA

}
2.
minor_sync( );

{
check_nibble
access_unit_length
input_timing
}

3.
substream_segment( )

{
do

block( );

while (!last_block_in_segment)
padding
if (last_access_unit_in_stream)

terminator

}

4.
block( )
{

if (block_header_exists)

{
if (restart_header_exists)

restart_header( );

block_header( );
}

. . . . . .
. . .
}
5.
restart_header( )
{
restart_sync_word
output_timing
. . . . . .
. . .
}
6.
block_header( )
{
. . . . . .
block_size( )
. . . . . .
. . .
}

Although the present invention has been described in detail with reference only to the presently preferred embodiments, those of ordinary skill in the art will appreciate that various modifications can be made without departing from the invention. As such, the present invention is not to be limited by the particularly described preferred embodiments. Rather, the scope of the present invention is to be determined from the claims, which follow.

What is claimed:

1. A playback system, comprising:
a depacketizer circuit coupled to receive packets of audio data from a storage device, the depacketizer circuit extracting data and outputting one or more data streams; and
at least one decoder core receiving the one or more data streams, the decoder decoding audio data according to a lossless unpacking scheme, wherein the depacketizer circuit and the at least one decoder core are coupled to provide data directly from the depacketizer circuit to the at least one decoder core without buffering.

2. The system of claim 1, further comprising a matrixing circuit for generating at least partially correlated audio output from three or more signal streams from the at least one decoder core.

3. The system of claim 1, wherein the at least one decoder core is two decoder cores, one decoder core receiving from the depacketizer circuit a substream comprising at least one audio channel, a second decoder core receiving from the depacketizer circuit a substream comprising up to four audio channels.

4. The system of claim 3, wherein the storage device is a DVD-Audio disk.

5. The system of claim 3, wherein the storage device is an optical storage disk.

6. The system of claim 3, wherein the storage device comprises a communications link between a data store and the depacketizer circuit.

7. The system of claim 1, wherein the at least one decoder core performs MLP decoding on data read from a DVD.

8. A playback system, comprising:
a depacketizer provided to receive packets of audio data from a storage device, the depacketizer extracting data and outputting one or more data streams; and
at least one decoder core receiving the one or more data streams, the decoder decoding audio data, wherein the depacketizer and the at least one decoder core are defined within a digital signal processor and provide data directly from the depacketizer to the at least one decoder core within the digital signal processor.

9. The system of claim 8, further comprising a matrixing circuit for generating at least partially correlated audio output from three or more signal streams from the at least one decoder core.

10. The system of claim 9, wherein the matrixing circuit is implemented in the digital signal processor.

11. The system of claim 9, further comprising a matrixing circuit for generating multichannel audio data, the matrixing circuit implemented within the digital signal processor.

12. The system of claim 11, wherein the at least one decoder core performs MLP decoding.

13. The system of claim 8, wherein the at least one decoder core comprises first and second decoder cores, the depacketizer providing a substream 0 to the first decoder core and providing a substream 1 to the second decoder core.

14. The system of claim 13, further comprising a matrixing circuit for generating multichannel audio data, the matrixing circuit implemented within the digital signal processor.

15. The system of claim 8, wherein data passes between the depacketizer and the at least one decoder core at 14.75 Mb/sec or higher.

16. An MLP encoding system, comprising:
a matrix circuit receiving a plurality of audio signal channels;
a first and second encoder core receiving data from the matrix circuit, the first and second encoders implementing MLP encoding on data output by the matrix circuit;
a packetizer receiving first and second data substreams from the first and second encoders, respectively, and formatting audio data into packets for storage on a storage medium, wherein the packetizer circuit and the first and second encoder cores are coupled to provide data directly from the first and second encoder cores directly without buffering.

17. The system of claim 16, wherein data passes between the first and second encoder and the packetizer at 14.75 Mb/sec or higher.
